(19) United States
(12) Patent Application Publication
(10) Pub. No.: US 2024/0234991 A9
(43) Pub. Date: Jul. 11, 2024

(54) FILLING HEAD

(71) Applicant: Manz AG, Reutlingen (DE)

(72) Inventors: Dirk KALTENMARK, Moessingen (DE); Jaro BAPP, Renningen (DE); Christoph BAEDER, Altbach (DE); Johannes GRIESSINGER, Moessingen (DE)

(73) Assignee: Manz AG, Reutlingen (DE)

(21) Appl. No.: 18/382,143

(22) Filed: Oct. 20, 2023

(30) Foreign Application Priority Data
Oct. 21, 2022 (EP) 22202925.8

(51) Int. Cl. H01M 50/609

(52) U.S. Cl. CPC H01M 50/609

(57) ABSTRACT

A filling head for filling an electrochemical cell with electrolyte has a pre-chamber and a filling chamber, as well as a shutoff element which is movable between an open position and a closed position and releases an opening between the pre-chamber and the filling chamber in the open position and closes off the opening in the closed position. The filling chamber has a pressure port. The shutoff element is movable against a restoring force from the closed position into the open position.

### CROSS REFERENCE TO RELATED APPLICATIONS

Applicant claims priority under 35 U.S.C. § 119 of European Application No. 22202925.8 filed Oct. 21, 2022, the disclosure of which is incorporated by reference.

### BACKGROUND OF THE INVENTION

### 1. Field of the Invention

The invention relates to a filling head for filling an electrochemical cell with electrolyte, the head comprising a pre-chamber and a filling chamber, as well as a shutoff element which is movable between an open position and a closed position and releases an opening of the pre-chamber in the open position and closes off the opening in the closed position.

### 2. Description of the Related Art

Such a filling head has become known, for example, from U.S. Pat. No. 8,047,241 B2. Batteries, in particular lithium-ion batteries, have gained an ever-greater importance. In the production of battery cells, stacks of electrode sheets or wound electrode sheets are arranged in a battery housing. The battery housing must subsequently be filled with an electrolyte. After filling, no more air, if possible, should be present in the electrodes.

In the device described in U.S. Pat. No. 8,047,241 B2 or in the method described therein for filling a battery cell with electrolyte, a large number of pressure and vacuum cycles is necessary. In addition, the electrolyte must be metered exactly.

### SUMMARY OF THE INVENTION

It is therefore an object of the present invention to provide a filling head with which the filling of electrochemical cells with electrolyte can be simplified and accelerated.

This object is achieved according to the invention by a filling head for filling an electrochemical cell with electrolyte, said head comprising a pre-chamber and a filling chamber, as well as a shutoff element, in particular a plunger, which is movable between an open position and a closed position and releases an opening of the pre-chamber in the open position and closes off the opening in the closed position. The filling chamber has a pressure port, and the shutoff element is movable against a restoring force from the closed position into the open position. While the pre-chamber in the cited prior art has a plurality of pressure ports, to which a plurality of valves is connected, according to the invention a pressure port on the filling chamber is provided. This enables decoupling between cost-intensive metering components and time-consuming vacuum and pressure cycles. In particular, a single pressure port can be provided for a high pressure (positive pressure) and a lower pressure (vacuum), which is low in comparison thereto. The pre-chamber can be filled in advance and the filling head can subsequently be moved to a process station, where the pressure and vacuum cycles and the filling of the cell are carried out.

The electrochemical cell (which is actually an electrochemical cell only after the filling with electrolyte) can be a battery cell or a capacitor or the like.

One or more valves can be connected to the pressure port. In addition, the pressure port can be connected to a vacuum source and/or a pressure source.

The filling chamber can have a port for filling with electrolyte. The filling of the filling chamber with electrolyte can take place decentrally, in particular outside of a process station in which the electrochemical cell is filled with electrolyte. A vent opening can be provided for venting the filling chamber.

Preferably, the filling head has no permanent connections to an electrolyte reservoir and to a vacuum/positive pressure system.

The opening, which can in particular be arranged on the underside of the pre-chamber, can open directly into the filling chamber. Alternatively, a tube which projects into the filling chamber can be connected at the opening. Furthermore, it is conceivable for a tube connected to the opening to project into the electrochemical cell to be filled and for electrolyte to first get into the electrochemical cell when the shutoff element is open and then to pass into the filling chamber when the electrochemical cell is virtually overflowing. A plurality of tubes can be provided. In particular, a plurality of openings comprising a tube connected thereto can be provided.

The shutoff element is movable against a restoring force from the closed position into the open position. Due to the restoring force, the shutoff element is always automatically moved into its closed position. Accordingly, the shutoff element does not have to be acted upon by a drive when the filling head pre-chamber filled with electrolyte is moved since the shutoff element is automatically in the closed position.

The restoring force is applied without media (no electricity, compressed air, hydraulics, etc. are required) and permanently. The shutoff element is therefore normally in a closed position. The shutoff element can only be opened by applying a force that overcomes the restoring force.

The pre-chamber can be permanently open to the surrounding atmosphere, e.g. via a filling opening and/or a vent opening.

A plurality of openings can be provided, which can be closed off by the shutoff element. In particular, the filling head can be adapted to the respective electrochemical cell, which is to be filled. For example, round or prismatic electrochemical cells which have a fill opening can be filled with a filling head which has only one opening between the pre-chamber and the filling chamber and which has a connection piece for connecting to the electrochemical cell. If, on the other hand, a round cell with an open cover is to be filled, it may be advantageous to provide a plurality of openings between the pre-chamber and the filling chamber. A better distribution of the electrolyte can thereby be achieved. The center can be kept free of electrolyte. It is possible to avoid electrolyte flowing onto disruptive contours and splashes being produced thereby. In addition, a more uniform inflow can be achieved by this measure.

In a further embodiment, the opening of the pre-chamber to the filling chamber can be provided with at least one tube, which projects into the filling chamber. As a result, the electrolyte can flow more calmly into the filling chamber. The tube can also be designed as a nozzle or diffuser in order to adapt the flow behavior.

The scope of the invention also includes a process device comprising a workpiece carrier for receiving at least one electrochemical cell to be filled with electrolyte and a cover which can be placed on the workpiece carrier, wherein at least one filling head according to the invention is arranged on the cover. Preferably, a plurality of filling heads is arranged on the cover. For example, four filling heads can be arranged on the cover. The cover has through-openings so that a fluidic connection can be produced between the filling head and an electrochemical cell arranged under the cover.

Thus, electrochemical cells to be filled can be inserted into the workpiece carriers. The cover can subsequently be placed on the workpiece carrier and a fluidic connection can be produced between the filling heads arranged on the cover and the electrochemical cells. The filling heads of the cover may already be filled with electrolyte before the cover is placed on the workpiece carrier.

The connection between the cover and the workpiece carrier can be designed to be fluid-tight. This can be used to enable a different or identical pressure level inside and outside the electrochemical cell. This seal also makes it possible, for example, to generate a vacuum in the electrochemical cell in the case of a non-fluid-tight seal between the filling chamber and the electrochemical cell.

At least one process port, which is connected to the pressure port of the filling chamber of the at least one filling head, can be provided on the cover and/or on the workpiece carrier. Thus, the process port of the cover and/or of the workpiece carrier can be connected to a pressure source and/or vacuum source at a process station.

In a further embodiment, at least one further process port can be provided on the workpiece carrier instead of or in addition to the process port on the cover. This further process port can serve to generate different pressures inside and outside the electrochemical cell. The process connection for the cover could also be realized only by the workpiece carrier so that the process port in the cover is not open toward the outside.

By means of a process port on the workpiece carrier, the interior of the process device, in particular the space between the electrochemical cell and the workpiece carrier, can be evacuated or subjected to positive pressure.

Further advantages result when the workpiece carrier has a resiliently mounted receptacle for receiving the at least one electrochemical cell. In this case, a resiliently mounted receptacle can be provided for each electrochemical cell. Tolerances and wear can thereby be compensated.

The scope of the invention furthermore includes an electrolyte filling arrangement comprising at least one filling station for filling the pre-chambers of filling heads arranged on a cover of a process device, a plurality of process stations, wherein each process station has at least one port to connect to a process port of a process device. It is thus possible to transport process devices to process stations, where the process device can be connected with its process port so that a positive pressure or a vacuum can be generated in the filling chamber. The filling of the pre-chambers with electrolyte takes place in the filling station, thus decoupled from the process stations. The throughput of the electrolyte filling arrangement can be increased by this separation of the stations. A flexible system design results. Large vacuum chambers can be dispensed with. The number of metering systems can be reduced compared to the prior art.

The electrolyte filling arrangement can have a cover cleaning station. A cleaning can thus be carried out before the filling heads are refilled with electrolyte and unused electrolyte can be removed.

In order to enable quality control, a weighing station can be provided on the loading side and/or on the unloading side. In particular, the electrochemical cells can be weighed before filling with electrolyte and after filling with electrolyte. This can ensure that the electrochemical cells were completely filled with electrolyte.

A transport device for transporting process devices and a transport device for transporting covers of process devices can be provided. The transport device can be used to transport process devices from a loading side to an unloading side of the electrolyte filling arrangement. In particular, the process devices can be transported by the transport device to process stations and then again from the process stations to the unloading side. After unloading, the covers can be transported back to the loading side. In this case, the process covers or the filling heads arranged thereon can first be cleaned and subsequently be filled before they reach the loading side. The return transport of the cover and the workpiece carrier can take place separately or jointly.

The scope of the invention furthermore includes a method for filling an electrochemical cell with an electrolyte using a filling head according to the invention with the method steps of:
a) Filling the pre-chamber of the filling head with an electrolyte, wherein the shutoff element is in a closed position, subsequently
b) Placing the filing head on an electrochemical cell to be filled,
c) Evacuating the filling chamber and the electrochemical cell,
d) Moving the shutoff element into the open position so that electrolyte flows from the pre-chamber into the filling chamber and the electrochemical cell, and
e) Moving the shutoff element into the closed position.

Because the pre-chamber is filled with the shutoff element closed, the filling of the pre-chamber can take place before the filling head is placed on the electrochemical cell to be filled. Even if the electrochemical cell is brought up to the filling head from below, this is understood in the sense of the invention as placing the filling head on the electrochemical cell. When the shutoff element is opened, electrolyte flows into the electrochemical cell, where applicable first into the electrochemical cell and then into the filling chamber, due to the prior evacuation of the electrochemical cell and of the filling chamber. The electrolyte is virtually drawn into the electrochemical cell. Ideally, no further application of pressure is necessary in order to completely fill the electrochemical cell with electrolyte. After the shutoff element is closed again, the remaining electrolyte can remain in the pre-chamber. The filling of the pre-chamber provides the metering accuracy, and thus the shutoff element can be opened and closed in any number of steps without affecting the absolute metering accuracy.

However, advantages result when a pressure greater than 1 bar is applied to the pressure port after the closing of the shutoff element. As a result, electrolyte can be pressed into the electrochemical cell. This enables the electrolyte to be received in the electrochemical cell in an accelerated manner.

Optionally, the shutoff element can subsequently be opened again so that electrolyte can flow into the filling chamber. A pressure can subsequently be applied again in order to press even more electrolyte into the electrochemical cell. Beforehand or afterward, there may be further evacuation steps or ventilation steps.

Interim evacuation can possibly be used to draw out the resulting gases. In particular, a plurality of pressure cycles (evacuation and/or positive pressure) can be carried out, even with short opening times of the shutoff element.

Step a) can be carried out both locally and temporally separately from step d). During step a), the filling head can be completely media-free (no connection to electricity, compressed air, hydraulics or similar). Step b) can be carried out both locally and temporally separated from step d). Steps c), d) and e) can be carried out locally at the same location and sequentially.

The electrochemical cell can first be evacuated by applying an absolute pressure of less than 500 mbar, in particular 5 mbar. Before opening the shutoff element, it is possible to flush to an absolute pressure above the vapor pressure of the electrolyte. The shutoff element can then be opened briefly. If the shutoff element is closed, a pressure of less than 500 mbar can be applied again. The shutoff element can then be opened again. After its closing, it is again possible to evacuate at a pressure of less than 500 mbar, and then the shutoff element can be opened again. When it is closed, an absolute pressure of more than 1 bar, e.g., 6 bar, can be applied. An absolute pressure of less than 500 mbar can subsequently be applied, then a high pressure of, for example, 6 bar can again be applied. A pressure of less than 500 mbar can then be applied again, and the shutoff element can thereafter be opened for refilling with electrolyte. Further steps with a high and low pressure applied can follow and, after a sequence of evacuation and positive-pressure steps, the shutoff element can be opened again. Each step in which the shutoff element is opened corresponds to a single metering step. The sum of the individual metering steps corresponds to the amount of electrolyte in the pre-chamber. Even higher absolute pressures of up to 12 bar or even up to 30 bar are conceivable.

Further features and advantages of the invention are apparent from the following detailed description of embodiments of the invention, with reference to the figures of the drawing, which show details essential to the invention, and from the claims. The features shown there are not necessarily to be taken to scale and are shown in such a way that the special features according to the invention can be made clearly visible. The various features can each be implemented individually for themselves or for a plurality of combinations of any kind in variants of the invention.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a rough schematic representation of a filling head, which is connected to an electrochemical cell;

FIG. 2 shows a further schematic representation of a filling head;

FIG. 3 shows an embodiment of a filling head for filling round cells with an open cover;

FIG. 4 shows a representation of a filling head for filling cells with a fill opening;

FIG. 5 shows an exploded view of a process device;

FIG. 6A shows an alternative embodiment of a process device;

FIG. 6B shows a part of the process device of FIG. 6A;

FIG. 7 shows a schematic representation of an electrolyte filling arrangement; and

FIG. 8 shows an embodiment of a process station.

### DETAILED DESCRIPTION OF PREFERRED EMBODIMENTS

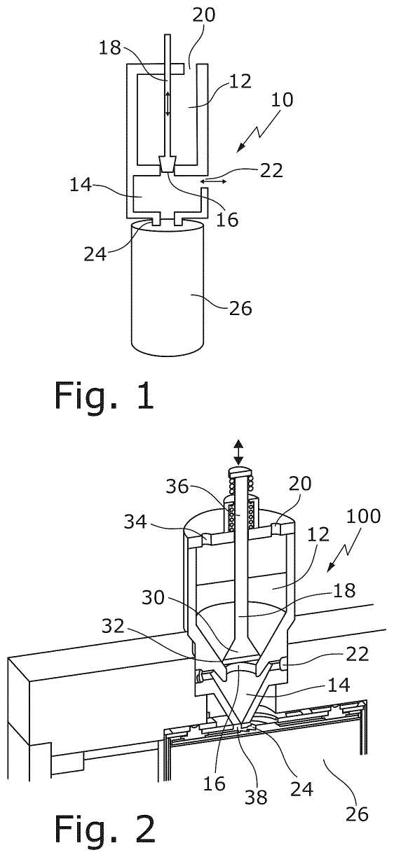

FIG. 1 shows a rough schematic representation of a filling head 10, which has a pre-chamber 12 and a filling chamber 14. Between the pre-chamber 12 and the filling chamber 14, an opening 16 is provided, which can be closed off by a shutoff element 18 designed as a plunger.

Electrolyte can be filled into the pre-chamber 12 through the filling opening 20, in particular when the shutoff element 18 is in a closed position and closes off the opening 16. The filling chamber 14 has a pressure port 22, which can be connected to a pressure source or a vacuum source. In particular, an absolute pressure in the range of 0.1 mbar to 100 bar, preferably in the range of 1 mbar to 10 bar, can be applied to the filling chamber 14 via the pressure port 22.

The filling head 10 furthermore has a connection piece 24 for connecting to an electrochemical cell 26 to be filled.

In order to fill the electrochemical cell 26, electrolyte can first be filled into the pre-chamber 12 through the filling opening 20 when the shutoff element 18 is closed, without the filling head 10 being connected to the electrochemical cell 26. The filling head 10 can subsequently be placed on the electrochemical cell 26, where applicable in a fluid-tight manner.

Both the electrochemical cell 26 and the filling chamber 14 can be evacuated via the pressure port 22, wherein the shutoff element 18 is in the closed position. In particular, after a valve connected to the pressure port 22 has been closed, the shutoff element 18 can subsequently be moved into an open position so that electrolyte can flow from the pre-chamber 12 into the filling chamber 14 and into the electrochemical cell 26. Due to the pressure, in particular a lower pressure in the filling chamber 14 than in the pre-chamber 12, electrolyte is virtually drawn into the electrochemical cell 26. The shutoff element 18 can subsequently be moved back into its closed position. Pressure greater than 1 bar, in particular in the range 1-10 bar, can be applied via the pressure port 22 in order to press additional electrolyte located in the filling chamber 14 into the electrochemical cell 26. Further cycles with vacuum/positive pressure can be carried out. The filling head 10 can subsequently be separated from the electrochemical cell 26.

FIG. 2 shows a further embodiment of a filling head 100. Elements corresponding to those of FIG. 1 bear the same reference numeral. It can be seen here that the filling chamber 14 tapers conically downward. The free end 30 of the shutoff element 18 is complementary to the opening 16 in order to be able to realize a good seal. In particular, the shutoff element 18 has a widening contour at its free end 30. A sealing edge 32 is formed between the shutoff element 18 and the opening 16.

In order to facilitate filling of the pre-chamber 12, a vent opening 34 can be provided.

From the closed position shown, the shutoff element 18 is movable into the open position against the restoring force of a spring element 36. The spring element 36 causes the shutoff element 18 to always be in a closed position without an external force application. This allows filling the pre-chamber 12 in a filling station without having to actuate the shutoff element 18 and transport it in the filled state through a filling arrangement.

A sealing edge 38 for sealing with respect to the electrochemical cell 26 is formed on the connection piece 24.

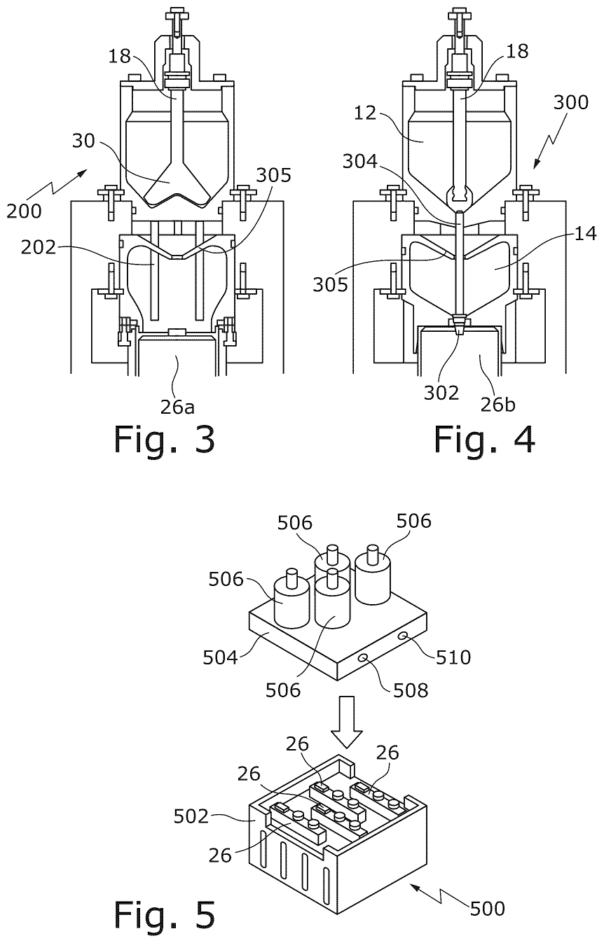

FIG. 3 shows a further alternative embodiment of a filling head 200, which is suitable for filling an electrochemical cell 26a designed as a round cell with an open cover. The free end 30 of the shutoff element 18 is designed such that a plurality of openings 16 can be closed or opened simultaneously. The opening of the pre-chamber 12 to the filling chamber 14 is provided with tubes 202, which project into the filling chamber 14. As a result, the electrolyte can flow more calmly into the filling chamber 14. The tubes 202 can also be designed as nozzles or diffusers in order to adapt the flow behavior.

In the embodiment of a filling head 300 according to FIG. 4, which is designed to fill an electrochemical cell 26b having a fill opening 302, it can be seen as a special feature that a tube 304 projects from the opening of the pre-chamber 12 into the fill opening 302 of the electrochemical cell 26b. When the shutoff element 18 is opened, electrolyte flows first into the electrochemical cell 26b and then through an annular gap into the filling chamber 14. The annular gap is formed since the outer diameter of the tube 304 is less than the inner diameter of the fill opening 302.

Electrolyte retention means 305 are provided in the filling chamber 14, which may be formed as a retention plate or baffle plate to retain foaming electrolyte. These are shown only in FIGS. 3 and 4, but may also be provided in other embodiments.

FIG. 5 shows a process device 500 with a workpiece carrier 502, which is designed to receive electrochemical cells 26. In this case, a resiliently mounted receptacle or holder can be provided for each electrochemical cell 26. The resiliently mounted receptacle or holder can cause the electrochemical cells 26 to be pressed from below against a cover 504, which is placed on the workpiece carrier 502. A plurality of filling heads 506, four in the exemplary embodiment shown, are arranged on the cover 504, wherein each filling head 506 can be designed like one of the above-described filling heads 10, 100, 200, 300. Process ports 508, 510 are provided on the cover 504 and are connected to the pressure ports 22 of the filling heads 506, wherein each filling head 506 is connected to only one process port 508, 510. Due to the offset arrangement of the filling heads 506, two process ports 508, 510 are provided, each of the process ports 508, 510 being connected to two filling heads 506.

One of the process ports 508, 510 can also be provided to evacuate and/or pressurize the (intermediate) space between the electrochemical cells 26 and the workpiece carrier 502. In this case, one of the process ports 508, 510 would be connected to all filling heads 506. Application of pressure to the intermediate space can help to prevent deformation of the electrochemical cells when the interior thereof is subjected to positive pressure or negative pressure.

An additional process port (not shown) can also be provided for applying pressure (positive pressure or negative pressure) to the intermediate space.

Furthermore, a process port can be provided on the workpiece carrier 502, which is connected to a pressure port of at least one filling head 506.

In particular, as many filling heads 506 are arranged on the cover 504 as receptacles are provided for electrochemical cells 26 in the workpiece carrier 502. By placing the cover 504 on the workpiece carrier 502, the filling heads 506 can be connected in a fluid-tight manner to the electrochemical cells 26 depending on the design of the filling heads 506 and electrochemical cells 26, so that filling with electrolyte can be carried out after a prior evacuation of the electrochemical cells 26.

A seal can be provided on the workpiece carrier 502 or the cover 504 so that workpiece carrier 502 and cover 504 can be connected to one another in a fluid-tight manner.

In the overall combination with workpiece carrier 502 and cover 504, very high (over)pressures can also be realized within the cell 26, since a counterpressure can be (independently) set around cell 26. The differential pressure between areas inside and outside the cell 26 can thus be equalized. Destruction of cell 26 (or a bursting membrane on the cell housing) can thus be avoided. The high pressures lead to an acceleration of the absorption behavior of electrolyte.

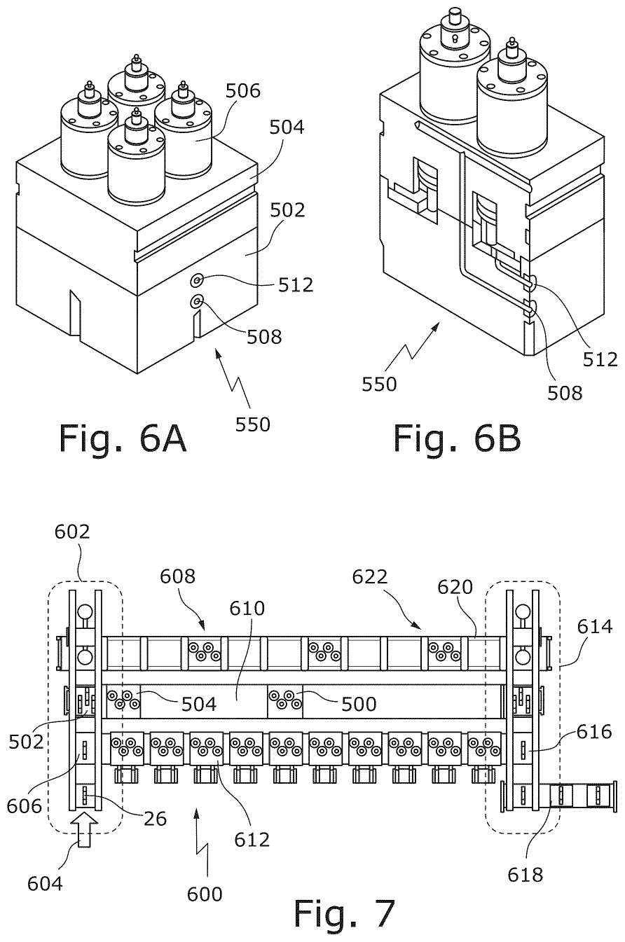

FIG. 6A shows an alternative embodiment of a process device 550. The cover 504 in turn has four filling heads 506, which are not, however, arranged offset. A process port 508 is arranged on the workpiece carrier 502 and is connected to the pressure ports of the filling heads 506.

In particular, a fluidic connection leads from the process port 508 through the workpiece carrier 502 and the cover 504 to the pressure ports of the filling heads 506. This can be seen in FIG. 6B, which shows a part of the process device 550.

Furthermore, a process port 512, which leads to the (intermediate) space between the electrochemical cells and the workpiece carrier 502, is provided on the workpiece carrier 502. The intermediate space can thus be evacuated or pressurized via the process port 512.

A seal is arranged between the workpiece carrier 502 and the cover 504 in order to seal them in a fluid-tight manner.

FIG. 7 shows an electrolyte filling arrangement 600. Electrochemical cells 26 can be supplied in a loading area 602 in the direction of arrow 604. In a weighing station 606, the electrochemical cell 26 is weighed before it is inserted into a workpiece carrier 502. When the workpiece carrier 502 is filled with electrochemical cells 26, a cover 504 is placed on the workpiece carrier 502. The filling heads 506 of the cover 504 were previously filled in a filling station 608.

Workpiece carrier 502 and cover 504 as well as the filling heads 506 are thus not a stationary part of a stationary machine. This means that the filling of the covers 504 or filling heads 506 with electrolyte can take place independently (in terms of location and time) of the filling process of the cell 26.

By means of a transport device 610, the process device 500, which has the workpiece carrier 502 and the cover 504, is fed to one of a plurality of process stations 612, where a connection to the process ports 508, 510 is established. The electrochemical cells 26 can then be filled with electrolyte in the process station 612. After filling, the process devices 500 arrive at an unloading area 614, where the cover 504 is removed and the electrochemical cells 26 are removed from the workpiece carrier 502, for example by means of a gripper. The individual electrochemical cells 26 are weighed again in a weighing station 616. The electrochemical cells 26 can be closed off at a closure station 618. The covers 504 pass through a transport device 620 from the unloading area 614 to a cleaning station 622, where the filling heads 506 are cleaned, in particular are rinsed. The cleaning process is thus separated in location and time, i.e. independent of the filling process of the cell 26 and the filling of the lids 504.

On the return path from the unloading area 614 to the loading area 602, the filling heads 506 are filled in the filling station 608. The filling of the filling heads 506 with electrolyte thus takes place at a different location than the filling of the electrochemical cells 26 with electrolyte.

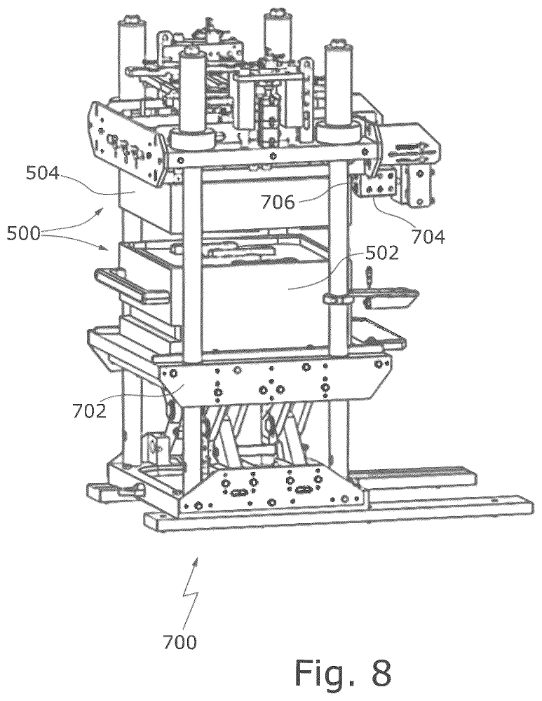

FIG. 8 shows an embodiment of a process station 700. The process station 700 has a height-adjustable receptacle 702 for a workpiece carrier 502. In this case, the cover 504 of the process device 500 is stationary at the process station 700, and the workpiece carrier is mobile and can be used at different process stations 700. By adjusting the height-adjustable receptacle 702 upwards, the workpiece carrier is moved upwards and thereby the lid 504 is placed on the workpiece carrier 502.

A filling station, not shown here, for filling prechambers 12 of filling heads 10, 100, 200, 300, 506 arranged on the lid 504 is stationarily installed above the process station 700. It is configured to supply several process stations 700. The filling station is thus spatially separated from the process stations 700 and is not assigned to only one process station 700. The filling station may have metering components for metering the electrolyte.

The lid 504 may be interchangeably disposed on the process station 700. In particular, the lid may be attached to the process station 700 via threaded rods, such as four threaded rods. Other attachment options are conceivable. For maintenance or adaptation to a particular cell design, the lid 504 can be easily disassembled and replaced.

A connection element 704 is provided at the process station 700. The cover 504 with its process ports can be connected to this connection element 704. The connection element 704 has seals 706 to provide a fluid-tight connection to the cover 504.

Although only a few embodiments of the present invention have been shown and described, it is to be understood that many changes and modifications may be made thereunto without departing from the spirit and scope of the invention.

What is claimed is:

1. A filling head for filling an electrochemical cell with electrolyte, comprising:
a pre-chamber,
a filling chamber, and
a shutoff element, which is movable between an open position and a closed position and releases an opening of the pre-chamber in the open position and closes off the opening in the closed position,
wherein the filling chamber has a pressure port, and wherein the shutoff element is movable against a restoring force from the closed position into the open position.

2. The filling head according to claim 1, wherein a plurality of the openings are provided, which can be closed off by the shutoff element.

3. The filling head according to claim 1, wherein a tube projects from the pre-chamber into the filling chamber and/or into an electrochemical cell to be filled.

4. A process device comprising a workpiece carrier configured for receiving at least one electrochemical cell to be filled with electrolyte and a cover which is configured to be placed on the workpiece carrier, wherein at least one filling head according to claim 1 is arranged on the cover.

5. The process device according to claim 4, wherein the workpiece carrier and the cover are connected or are connectable to one another in a fluid-tight manner.

6. The process device according to claim 4, wherein at least one process port is provided on the cover and/or on the workpiece carrier, said process port being connected to the pressure port of the filling chamber of the at least one filling head.

7. The process device according to claim 4, wherein a process port configured for evacuating the interior of the process device is provided on the workpiece carrier.

8. The process device according to claim 4, wherein the workpiece carrier has a resiliently mounted receptacle configured for receiving the at least one electrochemical cell.

9. An electrolyte filling arrangement comprising at least one filling station configured for filling pre-chambers of filling heads arranged on a cover of a process device, a plurality of process stations separate from the at least one filling station, each process station having at least one connection configured for connecting to a process port of a process device.

10. The electrolyte filling arrangement according to claim 9, wherein a weighing station is provided on a loading side and/or on an unloading side.

11. The electrolyte filling arrangement according to claim 9, wherein a transport device configured for transporting process devices and a transport device configured for transporting covers of process devices are provided.

12. A method for filling an electrochemical cell with an electrolyte using a filling head according to claim 1, comprising the method steps:
a. filling the pre-chamber of the filling head with an electrolyte, wherein the shutoff element is in a closed position, subsequently
b. placing the filling head on an electrochemical cell to be filled,
c. evacuating the filling chamber and the electrochemical cell,
d. moving the shutoff element into the open position so that electrolyte flows from the pre-chamber into the filling chamber and the electrochemical cell, and
e. moving the shutoff element into the closed position.

13. The method according to claim 12, wherein a pressure greater than 1 bar is applied to the pressure port after the shutoff element has been closed.

14. The method according to claim 12, wherein after step (e), the shutoff element is moved again into an open position.

15. The method according to claim 12, wherein a plurality of pressure cycles are carried out.

16. The method according to claim 15, wherein the plurality of pressure cycles are carried out when the shutoff element is in the open position.

17. The method according to claim 12, wherein the pre-chamber of the filling head is filled with electrolyte in a filling station of an electrolyte filling arrangement and the electrochemical cell is filled with electrolyte from the filling head in a process station of the electrolyte filling station.
